(19) United States
(12) Patent Application Publication
(10) Pub. No.: US 2025/0352299 A1
(43) Pub. Date: Nov. 20, 2025

(54) FIXING MEMBER AND GUIDING DEVICE INSTALLED ON AN IMPACTED TOOTH, METHOD FOR PASSING THE GUIDING DEVICE THROUGH THE IMPACTED TOOTH, AND TOOL FOR ASSISTING THE GUIDING DEVICE IN PASSING THROUGH THE IMPACTED TOOTH

(71) Applicant: LIANG-CHENG CHEN, Taichung City (TW)

(72) Inventor: LIANG-CHENG CHEN, Taichung City (TW)

(21) Appl. No.: 19/050,564

(22) Filed: Feb. 11, 2025

(30) Foreign Application Priority Data
May 16, 2024 (TW) 113118124
Dec. 27, 2024 (TW) 113151102

(51) Int. Cl. A61C 3/14

(52) U.S. Cl. CPC A61C 3/14

(57) ABSTRACT

A guiding device mounted on an impacted tooth, comprising a hook and a wire connected to the rear end of the hook. The hook has a curved shape and capable of passing through the transverse perforation of the impacted tooth. A method for passing the guiding device through the impacted tooth, by using the hook to guide the wire through the transverse perforation. A fixing member mounted on the impacted tooth, formed using the aforementioned method. A tool for assisting passing the guiding device through the impacted tooth, comprising a handle and a receiving portion connected to the handle, the receiving portion comprising a receiving hole and a slot. The receiving hole is capable of tightly receiving the hook of the guiding device, and the slot is in communication with the receiving hole, allowing the wire of the guiding device to pass through and extend out of the receiving portion.

### BACKGROUND OF INVENTION

### Field of Invention

The present invention relates to dental equipment, including a fixing member and a guiding device for an impacted tooth, a method for passing the guiding device through the impacted tooth, and a tool for assisting the guiding device in passing through the impacted tooth.

### Related Prior Art

An impacted tooth can be simply understood as a tooth that is stuck and cannot emerge. For example, the lower wisdom tooth is one of the most common types of impacted tooth. In the past, impacted tooth are removed through dental surgery; however, this method often causes pain and discomfort for the patient. Furthermore, after an impacted tooth is removed, a large bone cavity is left, which can reduce the support for the surrounding teeth and lead to bacterial growth. Additionally, during the removal process, pulling motions may damage nearby nerves.

A recently developed method for removing an impacted tooth involves first using the latest traction technology (see Taiwan Patent No. 1835699) to pull the impacted tooth out of its original position, and then extracts the impacted tooth through dental surgery. This method effectively addresses the various issues mentioned above. However, in this traction method, passing a wire through a perforation in the impacted tooth and pulling it to the outside of the tooth is not an easy task. Therefore, making the process of passing the wire through the impacted tooth easier has become a pressing concern.

### SUMMARY OF THE INVENTION

The present invention provides a guiding device for an impacted tooth, which makes it easier for a wire to pass through the impacted tooth. More specifically, the guiding device includes a hook and a wire. The hook has a curved shape and is capable of passing through a transverse perforation in the impacted tooth. One end of the wire is connected to the rear end of the hook, and the wire is able to pass through the transverse perforation. Using the guidance of the hook, the wire can smoothly pass through the transverse perforation.

In one embodiment, the hook of the guiding device of the present invention is more resistant to deformation than the wire.

In one embodiment, the hook of the guiding device of the present invention is harder than the wire.

In one embodiment, the hook and the wire of the guiding device of the present invention are integrally formed as a single, continuous piece.

In other embodiments, the front end of the hook of the various wire guiding devices of the present invention, after passing through the transverse perforation and entering the longitudinal cavity, faces an opening of the longitudinal cavity.

In another embodiment, a surface near a front end of the hook of the guiding device of the present invention has an anti-slip texture.

The present invention also provides a method for passing any of the above-described wire guiding devices through an impacted tooth, comprising the steps of: obtaining any of the guiding devices; inserting the front end of the hook of the guiding device into the transverse perforation of the impacted tooth; advancing the hook so that the front end of the hook enters the longitudinal cavity of the impacted tooth; and pulling the front end of the hook from the opening of the longitudinal cavity to the outside of the impacted tooth, so that the wire follows the hook to the outside of the impacted tooth.

In one embodiment, the method of the present invention further includes the steps of: cutting the wire to remove the hook; and joining the two ends of the wire after it has been cut.

In one embodiment, the method of the present invention further includes: inserting a measuring member into the transverse perforation of the impacted tooth and advancing it into the longitudinal cavity before inserting the hook into the transverse perforation, wherein the shape of the measuring member is the same as or similar to that of the hook, and the outer diameter of the measuring member is the same as or greater than the outer diameter of the hook.

The present invention further provides a fixing member mounted on an impacted tooth, formed using any one of the aforementioned methods, the fixing member comprises the wire and includes a closed loop passing through the transverse perforation of the impacted tooth and a connecting portion that connects the closed loop, wherein the closed loop surrounds a portion of the tooth wall of the impacted tooth, and the connecting portion comprises the two ends of the wire and is positioned outside the impacted tooth.

The present invention further provides a tool for assisting any of the aforementioned guiding device in passing the guiding device through the impacted tooth. The tool comprises a handle and a receiving portion connected to one end of the handle, wherein the receiving portion comprises an end, a receiving hole and a slot. The receiving hole extends from the end towards the handle, and capable of tightly receiving the hook of the guiding device. The slot is in communication with the receiving hole, extending from the end towards the handle and allows the wire of the guiding device to pass through and extends out of the receiving portion.

In one embodiment, the length of the receiving hole of the tool of the present invention is shorter than the length of the slot.

In one embodiment, the receiving portion of the tool of the present invention further comprises a limiting portion, which is located within the receiving hole and is capable of restricting the rotation of the hook.

In one embodiment, the tool of the present invention further comprises a measuring member connected to the other end of the handle, wherein the shape of the measuring member is the same as or similar to that of the hook, and the outer diameter of the measuring member is the same as or greater than the outer diameter of the hook.

Any of the devices, methods, or tools of the present invention all contribute to making the task of passing the wire through the impacted tooth easier, thereby facilitating the wider adoption of the aforementioned traction technique and also reducing the operation time required for the traction technique.

### BRIEF DESCRIPTION OF DRAWINGS

FIG. 1 is a perspective view of the guiding device and the tool according to an embodiment of the present invention;

FIG. 2 is a perspective view of the guiding device according to an embodiment of the present invention;

FIG. 3 is a perspective view of the guiding device according to another embodiment of the present invention;

FIGS. 4 to 6 are schematic views illustrating the implementation of the method for passing the guiding device through an impacted tooth according to the present invention;

FIGS. 7 and 8 are a plan view and a perspective view illustrating the fixing member formed by the method of the present invention;

FIG. 9 is a partial perspective view of the tool of the present invention;

FIGS. 10 and 11 are partial cross-sectional views of the tool of the present invention;

FIG. 12 is a partial perspective view of the tool according to another embodiment of the present invention;

FIG. 13 is a partial cross-sectional view of the tool according to another embodiment of the present invention;

FIG. 14 is a partial cross-sectional view of the tool according to another embodiment of the present invention;

FIG. 15 is a partial plan view of the measuring member of the present invention;

FIG. 16 is a side view of the tool of the present invention.

### DETAILED DESCRIPTION OF PREFERRED EMBODIMENT

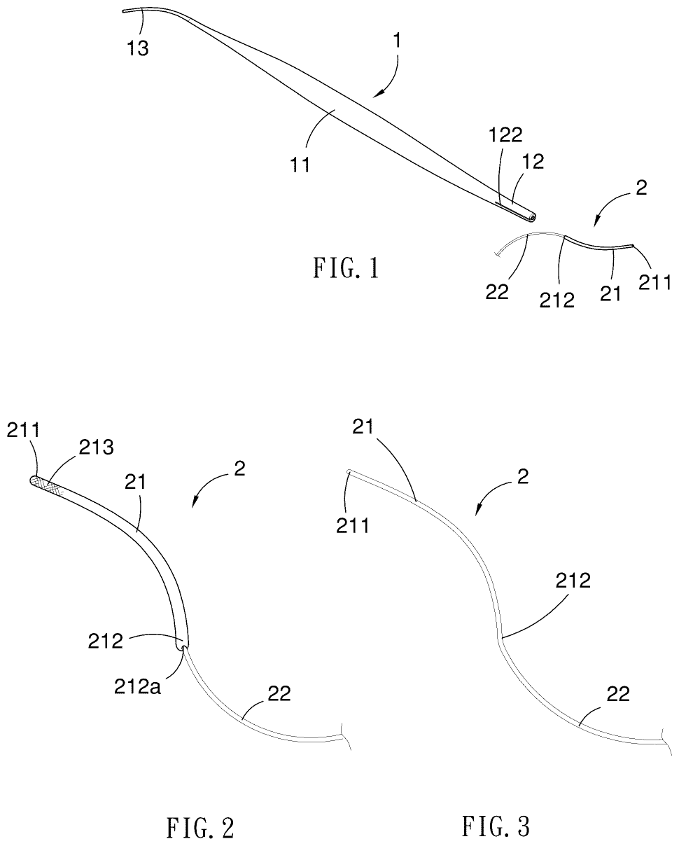

FIG. 1 illustrates one embodiment of a guiding device 2 of the present invention and one embodiment of a tool 1 for assisting the guiding device 2 in passing through an impacted tooth. The guiding device 2 includes a hook 21 and a wire 22 connected to the hook 21. The hook 21 has a curved shape, wherein the outer diameter of the hook 21 is the same as or greater than the outer diameter of the wire 22. One end of the wire 22 is connected to a rear end 212 of the hook 21. The wire 22 is made of a soft material, such as wire or synthetic fiber, but is not limited to this. The hook 21 is made of a hard material, which refers to a material that is harder than the soft material, and it can be made of metal or plastic. Thus, the hook 21 is more resistant to bending or deformation than the wire 22.

FIG. 2 shows that the rear end 212 of the hook 21 has a receiving hole 212a, into which one end of the wire 22 is inserted into. After the rear end 212 is flattened, it can clamp the end of the wire 22, thus completing the connection between the hook 21 and the wire 22. In this method, the hook 21 is made of a metal material, such as iron, steel, or alloy, but is not limited to these. In another method, the end of the wire 22 is also inserted into the receiving hole 212a, but the connection is made using adhesive. In this case, the hook 21 can be made of metal or rigid plastic materials, such as iron, steel, alloy, polyethylene, polypropylene, or plastic steel, but is not limited to these. Methods to connect the hook 21 and the wire 22 are not limited to the two described above; for example, the end of the wire 22 may be welded to the rear end 212 of the hook 21, or the end of the wire 22 may be tied to the rear end 212 of the hook 21.

FIG. 3 shows that the hook 21 and the wire 22 are made of the same metal material, such as thin iron wire. In this case, the two are connected by being integrally formed as a single, continuous piece, wherein the hook 21 has undergone a hardening treatment (such as heat treatment), so it has considerable hardness or rigidity, making it resistant to bending; whereas the wire 22 has not undergone hardening treatment, so it retains its inherent flexibility or bendability, making it easy to bend.

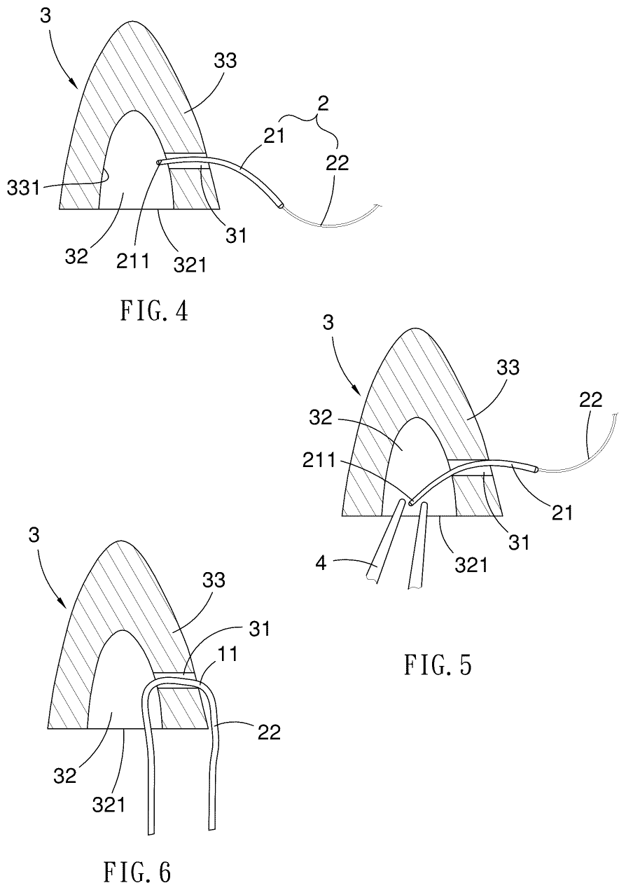

FIGS. 4 to 6 show the process of an embodiment for passing the guiding device 2 through an impacted tooth 3. The crown of the impacted tooth 3 has been previously removed, and a transverse perforation 31 and a longitudinal cavity 32 have been drilled. The longitudinal cavity 32 is enlarged and/or modified from the original pulp cavity, and its specific shape and size are determined based on the requirements. The transverse perforation 31 is formed in a tooth wall 33 surrounding the longitudinal cavity. An opening 321 of the longitudinal cavity 32 communicates with the outside (i.e., the oral cavity). The transverse perforation 31 passes transversely through the tooth wall 33 and reaches the longitudinal cavity 32, so that the longitudinal cavity 32 can communicate with the outside through the transverse perforation 31. The steps of executing the method are as follows:

First, as shown in FIG. 4, insert a front end 211 of the hook 21 into the transverse perforation 31 of the impacted tooth 3. Then, as shown in FIG. 5, advance the hook 21 so that the front end 211 of the hook 21 enters the longitudinal cavity 32. Since the hook 21 is relatively rigid, it is less likely to deform during the insertion into the perforation 31. Moreover, the curved shape of the hook 21 allows the front end 211 to avoid an inner surface 331 of the tooth wall 33 and direct towards the opening 321 of the longitudinal cavity 32, thus preventing the front end 211 from being caught by the inner surface 331.

Next, pull the front end 211 of the hook 21, which has entered the longitudinal cavity 32, and pulled out through the opening 321 to the outside of the impacted tooth 3, so that the wire 22 follows the hook 21 to the outside of the impacted tooth 3, as shown in FIG. 6.

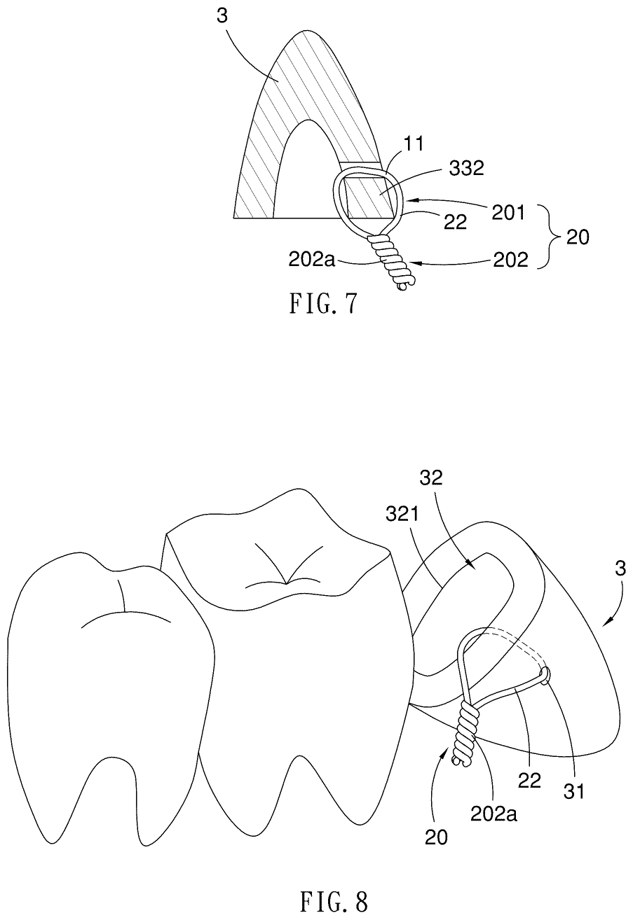

The aforementioned process of the method can be performed by a user using their fingers and/or a tweezer 4 shown in FIG. 5. Alternatively, it can also be performed using the tool 1 shown in FIG. 1, which will be discussed later. In any case, after passing the wire 22 through the impacted tooth 3 with the guidance of the hook 21, the wire 22 can be cut to remove the hook 21. Then, the two ends of the cut wire 22 are joined together to form a fixing member 20. As shown in FIGS. 7 and 8, the fixing member 20 includes a closed loop 201 passing through the transverse perforation 31 and a connecting portion 202 connecting the closed loop 201. The closed loop 201 surrounds a portion 332 of the tooth wall 33 of the impacted tooth 3, and the connecting portion 202 includes the two ends of the wire 22 and is located outside the impacted tooth 3.

In this embodiment, as shown in FIGS. 7 and 8, portions near both ends of the wire 22 are twisted and intertwined with each other to complete the connection of the two ends of the wire 22, thereby forming a twisted section 202a of the connecting portion 202. However, the aforementioned method is just one example, and the method of connecting the two ends of the wire 22 is not limited to this; for instance, knotting is also a feasible method.

The fixing member 20 can be used to connect an elastic band (not shown in the figures). For example, before joining the two ends of the wire 22, the wire 22 is passed through a hole in the elastic band. Thus, after the two ends of the wire 22 are connected, the elastic band is securely attached to the closed loop 201 formed by the wire 22 and will not detach freely. Alternatively, the connecting portion 202 can also be bent into a hook (not shown in the figures), which can be used to hook into the hole of the elastic band to complete the connection between the fixing member 20 and the elastic band. Next, the elastic band can be stretched, and its other hole can be hooked onto another fixing member (not shown in the figures), which is fixed to a tooth or jawbone near the impacted tooth 3. This fixing member has a protruding pin that can be inserted into the other hole of the elastic band. In this way, the elasticity of the elastic band itself can be used to slowly pull the impacted tooth 3 away from its original position, gradually moving the impacted tooth 3 farther from the alveolar nerve near its original position. During this process, the bone cavity left by the impacted tooth 3 can also gradually be refilled with newly formed bone.

Preferably, as shown in FIG. 2, the surface near the front end 211 of the hook 21 is also provided with an anti-slip texture 213, allowing the tweezer 4 to securely grip the hook 21 to pull the front end 211 of the hook 21 from the opening 321 to the outside of the impacted tooth 3.

Additionally, the hook 21 and the wire 22 may also be of the same hardness, as long as the hook 21 is not easily deformed when passing through the transverse perforation 31 of the impacted tooth 3, and the wire 22 can be bent to form the fixing member 20.

As described above, the hook 21 of the present invention can guide the wire 22 through the impacted tooth 3. This not only makes passing the wire 22 through the impacted tooth 3 easier, but also speeds up the formation of the fixing member 20. However, in situations where the user has proficient threading skills, the guidance of the hook 21 may not be needed. In this case, the wire without the hook 21 can be passed through the impacted tooth 3. Specifically, one end of the wire without the hook 21 is inserted into the transverse perforation 31 of the impacted tooth 3, then the wire is advanced so that the end of the wire enters the longitudinal cavity 32, and finally, the end of the wire, which has entered the longitudinal cavity 32, is pulled out through the opening 321 to the outside of the impacted tooth 3. In this case, the step of cutting the wire 22 described above is not necessary.

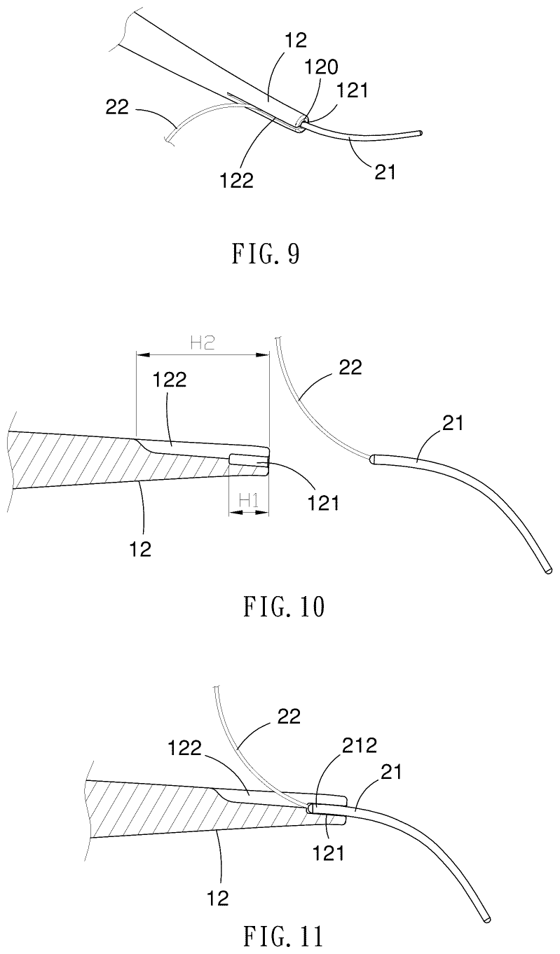

To assist in passing the guiding device 2 through the impacted tooth 3, the present invention also provides the tool 1, as shown in FIG. 1. The tool 1 includes a handle 11 and a receiving portion 12 connected to the handle 11. The handle 11 has a shape that facilitates easy gripping. As shown in FIGS. 9 and 10, the receiving portion 12 includes an end 120, a receiving hole 121 extending from the end 120 towards the handle 11 by a length H1, and a slot 122. The slot 122 is in communication with the receiving hole 121 and also extends from the end 120 of the receiving portion 12 towards the handle 11 by a length H2. Preferably, the length H1 is smaller than the length H2, but this is not limited.

As shown in FIGS. 9 and 11, the receiving hole 121 is used to tightly receive the rear end 212 of the hook 21 of the guiding device 2, in order to prevent the guiding device 2 from falling out. The slot 122 allows the wire 22 to pass through and extend out of the receiving portion 12. In this way, the user can easily pass the guiding device 2 through the impacted tooth 3 with the assistance of the tool 1, making the execution of the aforementioned method simple and quick.

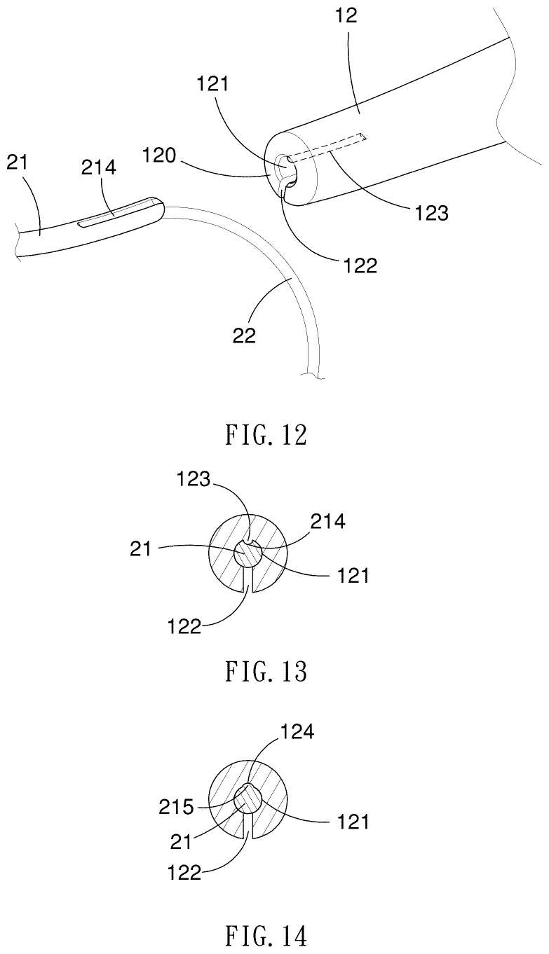

Preferably, the receiving portion 12 further includes a limiting portion located within the receiving hole 121, which restricts the rotation of the rear end 212 of the hook 21, making it difficult for the hook 21 to rotate relative to the receiving portion 12. For example, as shown in FIGS. 12 and 13, the limiting portion can be a protruding member123, which can fit into a groove 214 near the rear end 212 of the hook 21. Alternatively, as shown in FIG. 14, the limiting portion may also be the groove 124, into which a protrusion 215 near the rear end 212 of the hook 21 can be fitted.

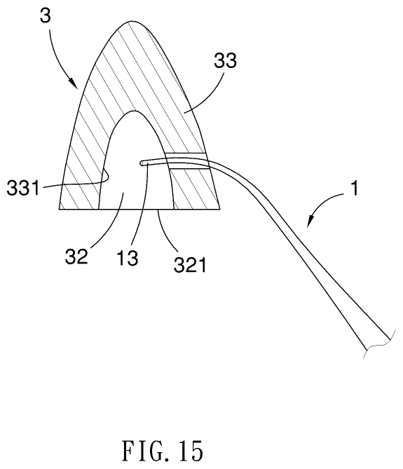

In the above method, preferably, before inserting the hook 21 or the wire into the transverse perforation 31 of the impacted tooth 3, a measuring member 13 can first be inserted into the transverse perforation 31 and advanced into the longitudinal cavity 32, as shown in FIG. 15. Since the shape of the measuring member 13 is the same as or similar to that of the hook 21, and the outer diameter of the measuring member 13 is the same as or greater than that of the hook 21, if the measuring member 13 can pass smoothly through the transverse perforation 31, it indicates that the hook 21 can also pass smoothly through the transverse perforation 31. Otherwise, it indicates that the transverse perforation 31 needs to be enlarged or modified. Similarly, since the outer diameter of the measuring member 13 is the same as or greater than the wire without the hook 21, if the measuring member 13 can pass smoothly through the transverse perforation 31, it indicates that the wire can also pass smoothly through the transverse perforation 31. Otherwise, it indicates that the transverse perforation 31 needs to be enlarged or modified. In short, the user can first use the measuring member 13 to preliminarily measure the transverse perforation 31 to decide whether to insert the hook 21 or the wire into the transverse perforation 31 of the impacted tooth 3, or whether to enlarge or modify the transverse perforation 31.

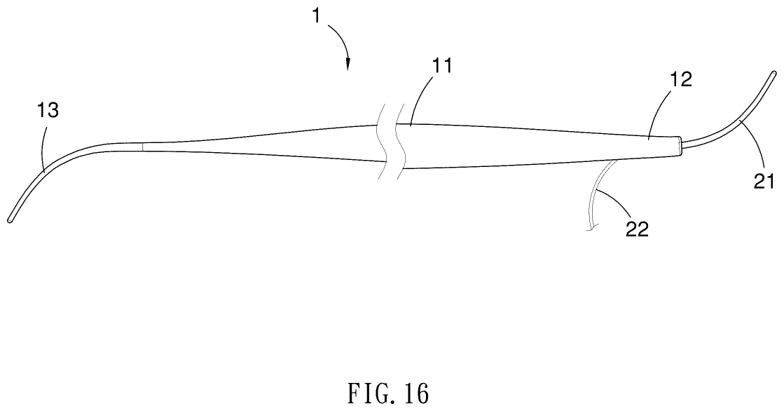

The measuring member 13 can be a separate tool with a handle (similar to the handle 11 in FIG. 1). Alternatively, as shown in FIGS. 1 and 16, the measuring member 13 can also be further integrated into the other end of the tool 1, making it easier for the user to perform the aforementioned measurement of the transverse perforation 31 and to pass the guiding device 2 or the wire through the transverse perforation 31. Preferably, the measuring member 13 and the slot 122 are on the same side, which causes the hook 21 mounted on the tool 1 to bend in the opposite direction. That is, the bending direction of the measuring member 13 and the hook 21 is opposite, but not limited to so. In one embodiment, the surface of the measuring member 13 may also have graduations marked thereon, which can be used to indicate the length and/or inner diameter of the transverse perforation 31. In this way, the user can use the measuring member 13 to measure the length and/or inner diameter of the transverse perforation 31.

1. A guiding device for an impacted tooth, wherein the impacted tooth comprises an longitudinal cavity, a tooth wall surrounding the longitudinal cavity, and a transverse perforation passing through the tooth wall and communicating with the longitudinal cavity, the guiding device comprising:
a hook, having a curved shape, and capable of passing through the transverse perforation; and
a wire, one end of which is connected to the rear end of the hook and capable of passing through the transverse perforation.

2. The guiding device as recited in claim 1, wherein the hook is more resistant to deformation than the wire.

3. The guiding device as recited in claim 1, wherein the hook is harder than the wire.

4. The guiding device as recited in claim 1, wherein the hook and the wire are integrally formed as a single, continuous piece.

5. The guiding device as recited in claim 1, wherein a surface near a front end of the hook has an anti-slip texture.

6. The guiding device as recited in claim 1, wherein a front end of the hook, after passing through the transverse perforation and entering the longitudinal cavity, faces an opening of the longitudinal cavity.

7. A method for passing the guiding device as recited in claim 1 through an impacted tooth, wherein the impacted tooth comprising a longitudinal cavity, a tooth wall surrounding the longitudinal cavity, and a transverse perforation passing through the tooth wall and communicating with the longitudinal cavity, the method comprising:
obtaining the guiding device;
inserting the front end of the hook of the guiding device into the transverse perforation of the impacted tooth;
advancing the hook so that the front end of the hook enters the longitudinal cavity; and
pulling the front end of the hook from the opening of the longitudinal cavity to the outside of the impacted tooth, so that the wire follows the hook to the outside of the impacted tooth.

8. The method as recited in claim 7, further comprising:
cutting the wire to remove the hook; and
joining the two ends of the wire after it has been cut.

9. The method as recited in claim 7, further comprising: inserting a measuring member into the transverse perforation of the impacted tooth and advancing it into the longitudinal cavity before inserting the hook into the transverse perforation, wherein the shape of the measuring member is the same as or similar to that of the hook, and the outer diameter of the measuring member is the same as or greater than the outer diameter of the hook.

10. A fixing member mounted on an impacted tooth, formed using the method as recited in claim 8, the fixing member comprising the wire and including a closed loop passing through the transverse perforation of the impacted tooth and a connecting portion connecting the closed loop, wherein the closed loop surrounding a portion of the tooth wall of the impacted tooth, and the connecting portion comprising the two ends of the wire and positioned outside the impacted tooth.

11. A tool for assisting in passing the guiding device as recited in claim 1 through the impacted tooth, comprising a handle and a receiving portion connected to one end of the handle, wherein the receiving portion comprising:
an end;
a receiving hole extending from the end towards the handle, capable of tightly receiving the hook of the guiding device; and
a slot, in communication with the receiving hole, extending from the end towards the handle and allowing the wire of the guiding device to pass through and extend out of the receiving portion.

12. The tool as recited in claim 11, wherein the length of the receiving hole is shorter than the length of the slot.

13. The tool as recited in claim 11, wherein the receiving portion further comprises a limiting portion, which is located within the receiving hole and is capable of restricting the rotation of the hook.

14. The tool as recited in claim 11, further comprising a measuring member connected to the other end of the handle, wherein the shape of the measuring member is the same as or similar to that of the hook, and the outer diameter of the measuring member is the same as or greater than the outer diameter of the hook.
